(19) United States
(12) Patent Application Publication
(10) Pub. No.: US 2022/0107738 A1
(43) Pub. Date: Apr. 7, 2022

(54) READ CONTROLLER AND INPUT/OUTPUT CONTROLLER

(71) Applicant: Kioxia Corporation, Tokyo (JP)

(72) Inventors: Yoshihiro Ohba, Kawasaki Kanagawa (JP); Takeshi Ishihara, Yokohama Kanagawa (JP); Takaya Ogawa, Kawasaki Kanagawa (JP); Hajime Matsui, Yokohama Kanagawa (JP)

(21) Appl. No.: 17/348,447

(22) Filed: Jun. 15, 2021

(30) Foreign Application Priority Data
Oct. 6, 2020 (JP) 2020-169245
Mar. 16, 2021 (JP) 2021-042454

(51) Int. Cl. G06F 3/06; G06F 21/60; G06F 21/79

(52) U.S. Cl. CPC G06F 3/0622; G06F 3/0611; G06F 3/0605; G06F 21/79; G06F 3/0679; G06F 21/602; G06F 3/0659

(57) ABSTRACT

According to one embodiment, a read controller reads data and metadata from a nonvolatile memory. The read controller includes a reader, a read mode changer and a first data processor. The reader reads first data and first metadata from the nonvolatile memory. The read mode changer determines whether to execute sequential processing for the first data based on the first metadata. When the read mode changer determines that the sequential processing is to be executed, the first data processor stores information necessary for the sequential processing, executes the sequential processing for the first data, and generates second metadata including a result of the sequential processing. The read controller outputs the first data, and the first metadata or the second metadata.

### CROSS-REFERENCE TO RELATED APPLICATIONS

This application is based upon and claims the benefit of priority from Japanese Patent Applications No. 2020-169245, filed Oct. 6, 2020; and No. 2021-042454, filed Mar. 16, 2021, the entire contents of all of which are incorporated herein by reference.

### FIELD

Embodiments described herein relate generally to a read controller and an input/output controller.

### BACKGROUND

In general, dedicated hardware for sequentially inputting data having a specific multimedia format, decoding the data, and outputting the decoded data, which is referred to as a decoder, is used to decode multimedia data such as video and voice. Examples of the decoder include a dedicated decoder machine, general-purpose computing on GPU (GPGPU), and a CPU-incorporated decoder. Examples of the dedicated decoder machine include, for example, DVD players which decode multimedia data stored in DVD media and digital TV tuners which decode multimedia data received from broadcast waves. The GPGPU is capable of executing general-purpose processing such as CPU in addition to normal GPU. For example, CPU processing load can be remarkably reduced by decoding H.264 video data by GPGPU. In addition, according to a certain method, the CPU processing load can be reduced without GPGPU by providing a dedicated decoder circuit for a die of the CPU (Intel Quick Sync Video and the like).

In addition, according to a certain technique, when information of high confidentiality is stored in a storage device, a host CPU does not execute encryption, but executes encryption and decryption using an encryption unit built in the storage device and then executing writing and reading. In addition, according to another technique, I/O processing is executed between the storage device handling the information of high confidentiality and an appropriately verified host CPU.

When multimedia data stored in a storage such as a flash memory or a hard disk are handled, not only decoding, but also data redistribution need to be considered. The dedicated decoder machine is specialized for decoding alone and is inapplicable to data redistribution. In contrast, the GPGPU and the CPU-incorporated decoder need to read the encoded data from the storage to the memory and to write the decoded data to the memory again after decoding.

The same problem also exists in the encryption and decryption. That is, when the information encrypted with a certain encryption key is redistributed, the encryption key needs to be exchanged or shared-. Sharing the encryption key is unrealistic, and the information read from the storage device to exchange the encryption key needs to be encrypted again by the CPU and redistributed.

### BRIEF DESCRIPTION OF THE DRAWINGS

FIG. 1 is a configuration diagram illustrating a read control module of a first embodiment.

FIG. 2 is a diagram illustrating an example of metadata in a case of using NVMe SSD as a nonvolatile storage in the first embodiment.

FIG. 3 is a diagram illustrating an example of codec information in the first embodiment.

FIG. 4 is a flowchart illustrating an operation procedure of the read control module of the first embodiment.

FIG. 5 is a configuration diagram illustrating a read control module of a second embodiment.

FIG. 6 is a flowchart illustrating an operation procedure of the read control module of the second embodiment.

FIG. 7 is a configuration diagram illustrating an I/O control module of a third embodiment.

FIG. 8 is a flowchart illustrating an operation procedure of a write control module of the third embodiment.

FIG. 9 is a configuration diagram illustrating an I/O control module of a fourth embodiment.

FIG. 10 is a flowchart illustrating an operation procedure of a write control module of the fourth embodiment.

FIG. 11 is a configuration diagram illustrating an I/O control module of a fifth embodiment.

FIG. 12 is a configuration diagram illustrating a read control module of a sixth embodiment.

FIG. 13 is a configuration diagram illustrating a read control module of a seventh embodiment.

FIG. 14 is a configuration diagram illustrating an I/O control module of an eighth embodiment.

FIG. 15 is a configuration diagram illustrating an I/O control module of a ninth embodiment.

FIG. 16 is a configuration diagram illustrating an I/O control module of a tenth embodiment.

FIG. 17 is a configuration diagram illustrating a computer using an I/O control module of the embodiment.

FIG. 18 is a configuration diagram illustrating a computer using the I/O control module of the embodiment, and an extended metadata generation server.

FIG. 19 is a configuration diagram illustrating a network storage device using the I/O control module of the embodiment.

FIG. 20 is a configuration diagram illustrating a network storage device in a case where the I/O control module illustrated in FIG. 19 is integrated with the network interface.

### DETAILED DESCRIPTION

Embodiments will be described hereinafter with reference to the accompanying drawings.

In general, according to one embodiment, a read controller reads data to be subjected to sequential processing and metadata from a nonvolatile memory. The read controller includes a reader, a read mode changer, and a first data processor. The reader reads first data and first metadata from the nonvolatile memory. The read mode changer determines whether or not to execute the sequential processing for the first data based on the first metadata. When the read mode changer determines that the sequential processing is to be executed, the first data processor stores information necessary for the sequential processing; executes the sequential processing for the first data; and generates second metadata including a result of the sequential processing. The read controller outputs the first data, and the first metadata or the second metadata.

### First Embodiment

First, a first embodiment will be described.

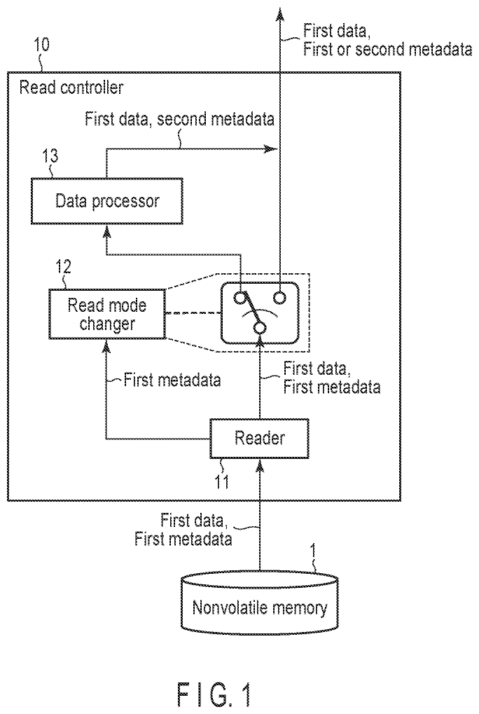

FIG. 1 illustrates a configuration example of a read control module (read controller) 10 according to the present embodiment. In FIG. 1, the read control module 10 is composed of a reader 11, a read mode changer 12, and a data processor (first data processor) 13. The reader 11, the read mode changer 12, and the data processor 13 may be implemented by hardware such as electric circuits or implemented by programs (software) run by processors (not illustrated).

The read control module 10 reads first data and first metadata from a nonvolatile memory 1, and delivers the data to the read mode changer 12. The read mode changer 12 determines whether to deliver the first data and the first metadata to the data processor 13 or output the data as they are to the outside, with the first metadata. When inputting the first data and the first metadata from the read mode changer 12, the data processor 13 sequentially processes the first data and the first metadata, and then outputs the first data and second metadata including the sequentially processed data to the outside.

The read mode changer 12 outputs the first data and the first metadata as they are to the outside in a case of, for example, not decoding but redistributing the enclosed data stored in the nonvolatile memory 1. When sequentially processing the input data, the data processor 13 stores a state necessary for sequential processing as an internal state. Examples of the internal state include, for example, a reference frame in the H.264 moving image compression, or a value of digital authentication to a block in a blockchain digital ledger.

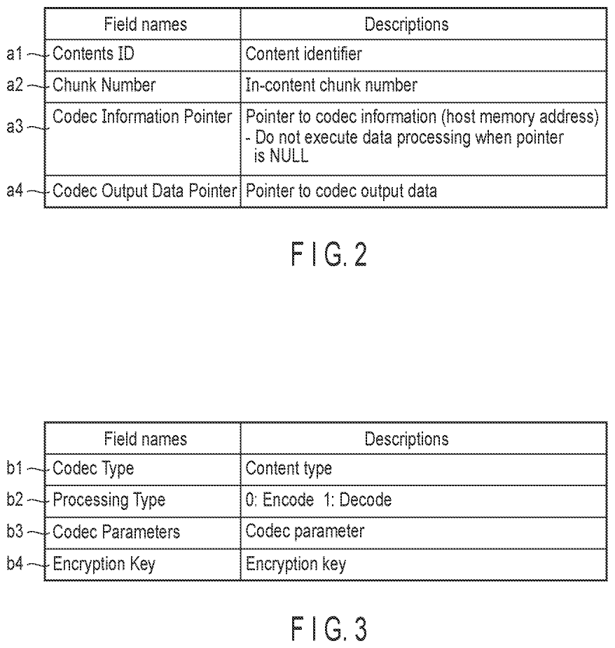

Next, FIG. 2 illustrates an example of the first metadata in the present embodiment. In FIG. 2, the first metadata is composed of Contents ID (a1), Chunk Number (a2), Codec Information Pointer (a3), and Codec Output Data Pointer (a4). Incidentally, the metadata may be included in, for example, a part of metadata defined under NVMe specifications.

Contents ID (a1) is a content identifier. Data associated with metadata including different content identifiers can be encoded or decoded in parallel.

Chunk Number (a2) is a number for identification assigned when the content is divided into a plurality of chunks. The definition of the chunk is varied depending on the data processed by the read control module 10. For example, when Codec Type to be described later is indicative of MPEG4, the chunk may correspond to one Box of MPEG4. Alternatively, when Codec Type to be described later is indicative of Encrypted H.264 NALU (https://developer.apple.com/lifbrary/archive/documentation/AudioVideo/Conceptual/HLS_Sample_Encryption/Encryption/Encryption.html), the chunk may correspond to one Media Data Container Box including Encrypted H.264 NALU. Alternatively, when Codec Type to be described later is indicative of Encrypted AAC (Advanced Audio Code) Frame (https://developer.apple.com/library/archive/documentation/AudioVideo/Conceptual/HLS_Sample_Encryption/Encryption/Encryption.html), the chunk may correspond to one Media Data Container Box including an encrypted AAC frame. Alternatively, when Codec Type to be described later is indicative of a blockchain, the chunk may correspond to one block of the blockchain digital ledger.

Codec Information Pointer (a3) is a pointer to the codec information that the data processor 13 of the read control module 10 refers to. If it is supposed that the codec information is stored in a memory space of a host (not shown) connected to the read control module 10, this pointer is an address of the memory space of the host. When the Codec Information Pointer is empty (NULL), this indicates that the codec process is not executed in the data processor 13 of the read control module 10. That is, the read mode changer 12 of FIG. 1 changes an operation to output the first data and the first metadata as they are to the outside.

Codec Output Data Pointer (a4) is a pointer to the data for which the data processor 13 of the read control module 10 executes the codec process. When processed data is arranged in the memory space on the host, the pointer becomes an address of the data.

Next, an example of the codec information described with reference to FIG. 2 is illustrated in FIG. 3. The codec information is composed of Codec Type (b1), Processing Type (b2), Codec Parameters (b3), and Encryption Key (b4). The Codec Type (b1) is indicative of a codec type (for example, Encrypted H.264 NALU). The Processing Type (b2) is indicative of either 0 (encoding process) or 1 (decoding process). The Codec Parameters (b3) are indicative of codec parameters inherent to respective codec types. The Encryption Key (b4) is indicative of an encryption key used when the data is subjected to security encryption processing or security decryption processing in the encoding process or the decoding process, or an identifier of the encryption key. The encryption key may be a common key of a common key encryption, a public key of a public key encryption, a private key of a public key encryption or any combination thereof. When the identifier of the encryption key is specified, the encryption key stored in the memory space of the inside of the read control module 10 or a host set in advance is identified with the value of the identifier, and the encryption key is used for the security encryption processing or the security decryption processing.

When the above-mentioned Codec Type (b1) is indicative of a blockchain, a digital signature computation process may be used as the security encryption processing and a public key of a signer where a digital signature is applied to the chunk may be specified as the Encryption Key (b4). At this time, the digital signature computation process may be executed with a private key of the signer which is associated with the public key of the signer designated as the Encryption Key (b4) and which is set in advance in the data processor, in the encoding process, and the digital signature computation process may be executed with the public key of the signer designated as the Encryption Key (b4), in the decoding process.

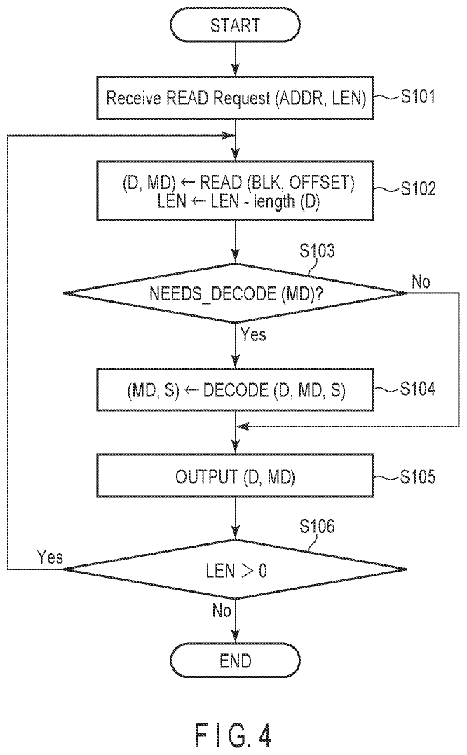

Next, a flowchart relating to the read control module 10 in the first embodiment illustrated in FIG. 1 is illustrated in FIG. 4. Input and output of the information will be described below with general-purpose expressions without identifying the relationship in connection with the host or the relationship in connection with the nonvolatile memory 1 but, in fact, orders based on various protocols can be used.

This operation is started by receiving a read request to the nonvolatile memory 1, which the host connected to the read control module 10 issues. It is assumed here that a request accompanied by an identifier (for example, an address) specifying the information to be read and a length of the identifier has been received (S101). Then, the read control module 10 specifies a logical block of the nonvolatile memory 1 which is to be actually read from the specified identifier (not shown).

Next, the read control module 10 reads data D and metadata MD associated with the data D from a predetermined location of the nonvolatile memory 1 specified by a block number BLK of a read target logical block and the number of bytes OFFSET from a starting part of the read target logical block ((D,MD)←READ(BLK,OFFSE)). Then, the read control module 10 subtracts a length of the read data D from a length LEN of the request (S102).

Next, the read control module 10 determines whether the decoding process needs to be executed by referring to a predetermined field (for example, the Codec Information Pointer (a3) of FIG. 2) of the metadata MD accompanying the read data D (NEEDS_DECODE(MD)) (S103).

When determining that the decoding process needs to be executed (for example, when the Codec Information Pointer (a3) of FIG. 2 is not NULL) (S103: Yes), the read control module 10 decodes the data D with information included in the metadata MD and a current state S of the decoder, puts the pointer for the decoded data to a predetermined field (for example, Codec Output Data Pointer of FIG. 2) of the MD, and updates the state S of the decoder ((MD,S)←DECODE(D,MD,S)) (S104). When determining that the decoding process does not need to be executed (for example, when the Codec Information Pointer (a3) of FIG. 2 in the case of NULL) (S103: No), the read control module 10 does not execute any process for the data D or the metadata MD.

Finally, the read control module 10 outputs the data D processed (or not processed) in accordance with the meta-information MD, and the metadata MD to an external module (OUTPUT(D,MD)) (S105). Incidentally, when the updated state S refers to failure of the decoding process, the output data D may be NULL indicating that no value exists or an indefinite value.

The read control module 10 ends the process when all the information corresponding to the required length is read and output (LEN>0 is false) (S106: No), or returns to the reading process if the data to be read still exists (LEN>0 is true) (S106: Yes).

The above is the operation in the present embodiment. The read control module 10 can determine the necessity of the process for the information stored in the nonvolatile memory 1, in accordance with the accompanying metadata and, if the processing is necessary which contiguously reading the data, can execute the process. An advantage of reducing much data transfer between the nonvolatile memory 1 executing the process and the host CPU can be thereby achieved.

That is, in the present embodiment, processing of the data to be sequentially processed, which are stored in the storage, can be executed efficiently in consideration of redistribution of the data.

### Second Embodiment

Next, a second embodiment will be described. A configuration of the present embodiment is the same as the first embodiment, but different in flow of the data and the metadata. Particularly, the embodiment is effective when the data size is the same before and after processing.

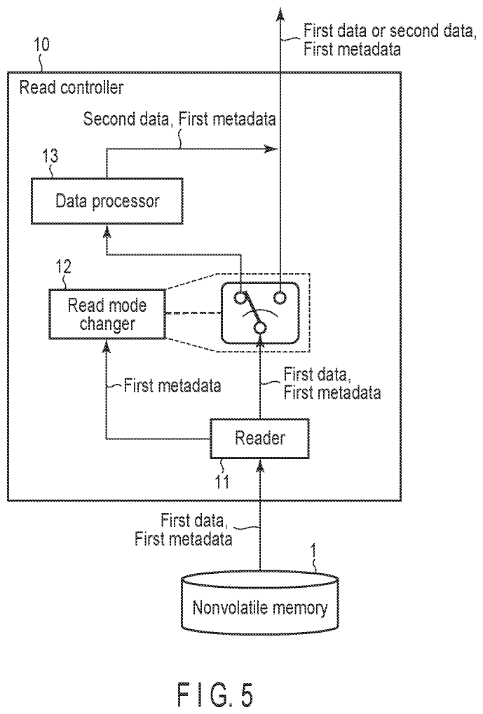

FIG. 5 illustrates a configuration example of a read control module (read controller) 10 of the present embodiment. In FIG. 5, the read control module 10 is composed of a reader 11, a read mode changer 12, and a data processor 13.

The read control module 10 reads first data and first metadata from a nonvolatile memory 1, and delivers the data to the read mode changer 12. The read mode changer 12 determines whether to deliver the first data and the first metadata to the data processor 13 or output the data as they are to the outside, with the first metadata. When inputting the first data and the first metadata from the read mode changer 12, the data processor 13 sequentially processes the first data and the first metadata, and then outputs second data including the sequentially processed data and the first metadata to the outside.

The read mode changer 12 outputs the first data and the first metadata as they are to the outside in a case of, for example, not decoding but reading the enclosed data stored in the nonvolatile memory 1 for redistribution.

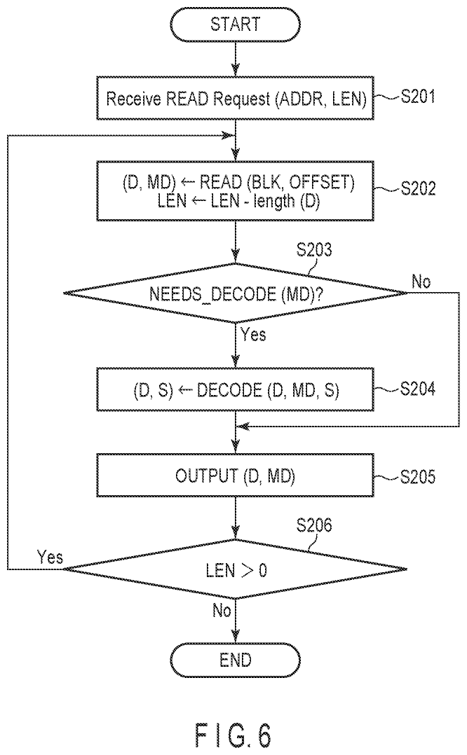

Next, a flowchart relating to the read control module 10 in the second embodiment illustrated in FIG. 5 is illustrated in FIG. 6. Input and output of the information will be described below with general-purpose expressions without identifying the relationship in connection with the host or the relationship in connection with the nonvolatile memory 1 but, in fact, orders based on various protocols can be used.

This operation is started by receiving a read request to the nonvolatile memory 1 which the host connected to the read control module 10 issues. It is assumed here that a request accompanied by an identifier (for example, an address) specifying the information to be read and a length of the identifier has been received (S201).

Then, the read control module 10 specifies a logical block of the nonvolatile memory 1 which is to be actually read from the specified identifier (not shown).

Next, the read control module 10 reads data D and metadata MD associated with the data D from a predetermined location of the nonvolatile memory 1 specified by a block number BLK of a read target logical block and the number of bytes OFFSET from a starting part of the read target logical block ((D,MD)←READ(BLK,OFFSE)). Then, the read control module 10 subtracts a length of the read data D from a length LEN of the request (S202).

Next, the read control module 10 determines whether the decoding process needs to be executed by referring to a predetermined field (for example, the Codec Information Pointer (a3) of FIG. 2) of the metadata MD accompanying the read data D (NEEDS_DECODE(MD)) (S203).

When determining that the decoding process needs to be executed (for example, when the Codec Information Pointer (a3) of FIG. 2 is not NULL) (S203: Yes), the read control module 10 decodes the data D with information included in the metadata MD and a current state S of the decoder, puts the pointer for the decoded data to D, and updates the state S of the decoder ((D,S)←DECODE(D,MD,S)) (S204). When determining that the decoding process does not need to be executed (for example, when the Codec Information Pointer (a3) of FIG. 2 in the case of NULL) (S203: No), the read control module 10 does not execute any process for the data D or the metadata MD.

Incidentally, when the updated state S refers to failure of the decoding process, the output data D may be NULL indicating that no value exists or an indefinite value.

The present embodiment is different from the first embodiment with respect to a feature of outputting the processed data to the outside in a form of being replaced with data to be processed. Conventionally, it has been necessary to read the information stored in the nonvolatile memory 1 without change but, in the present embodiment, the information obtained by processing the stored information can be output on the premise that a subject (application or the like) requesting reading corresponds to the information. Thus, the present embodiment achieves an advantage of further reducing an information amount read from the nonvolatile memory 1 and executing the information processing more efficiently than the first embodiment.

### Third Embodiment

Next, a third embodiment will be described. In the present embodiment, a simple write process is added to the first embodiment.

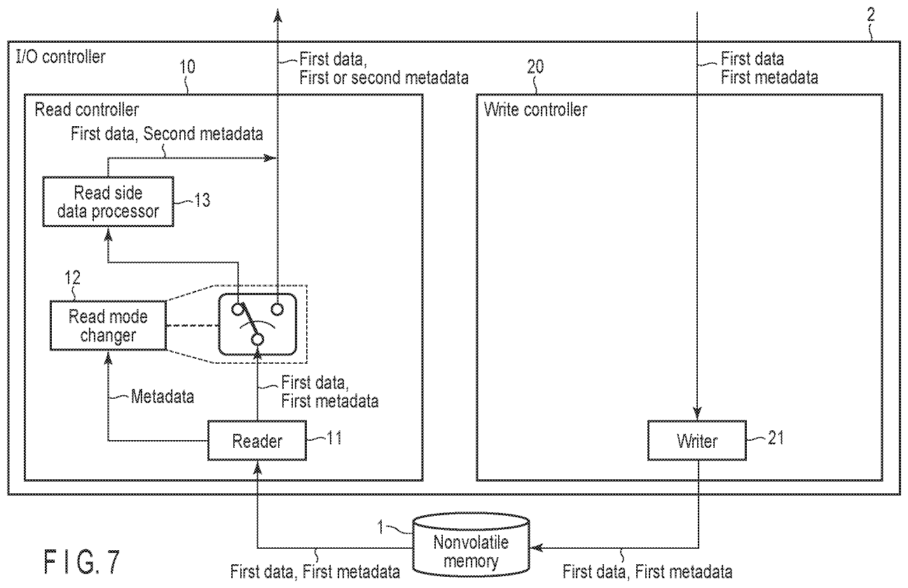

FIG. 7 illustrates a configuration example of an I/O control module (input/output controller) 2 according to the present embodiment. In FIG. 7, the I/O control module 2 is composed of a write control module (write controller) 20 and a read control module 10. The write control module 20 is composed of a writer 21, and the writer 21 receives first data and first metadata from the outside of the I/O control module 2 as inputs, and writes the inputs to the nonvolatile memory 1. The writer 21 may be implemented by hardware such as an electric circuit or implemented by a program (software) run by a processor (not illustrated).

Since the read control module 10 is the same as the read control module 10 in the first embodiment, detailed description thereof is omitted. Incidentally, a data processor 13 of the above-described read control module 10 is also hereinafter referred to as a read side data processor 13.

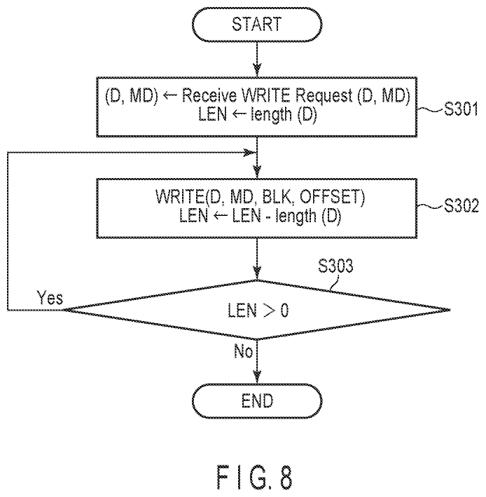

FIG. 8 illustrates a flowchart of a write control module 20 of the present embodiment. When receiving data D and metadata MD from the outside, the operation of the write control module 20 is started (Receive WRITE Request(D,MD)). The length of the data D may be received independently or included as a part of the metadata MD. It is assumed here that the length is specified in any method (LEN←length(D)) (S301).

Next, the write control module 20 writes the data D and the metadata MD to predetermined locations in the nonvolatile memory 1 specified by a block number BLK of a write target logical block and the number of bytes OFFSET from a starting part of the write target logical block (WRITE(D,MD,BLK,OFFSET)). In addition, the length of writing is reduced, and unprocessed data length is updated (LEN←LEN(D)) (S302). The flow returns to the write process when unwritten data exists (LEN>0 is true) (S303: Yes) or is ended when unwritten data does not exist (LEN>0 is false) (S303: No).

Incidentally, a series of explanation is omitted. When LEN>0 is true and when writing occurs a plurality of times, the block number BLK and offset byte number OFFSET of the write target logical block are appropriately updated for each writing, and then writing is executed.

The above is the third embodiment. The processing required at reading can be executed by allowing not only the data but the metadata including the processing information to be stored in the nonvolatile memory 1 together with the data at the writing. Incidentally, the write process is added to the configuration of the first embodiment here, and addition of the write process to the configuration of the second embodiment can also be implemented in the same manner.

### Fourth Embodiment

Next, a fourth embodiment will be described. In the present embodiment, a sequential processing operation at the time of writing is added to the first embodiment.

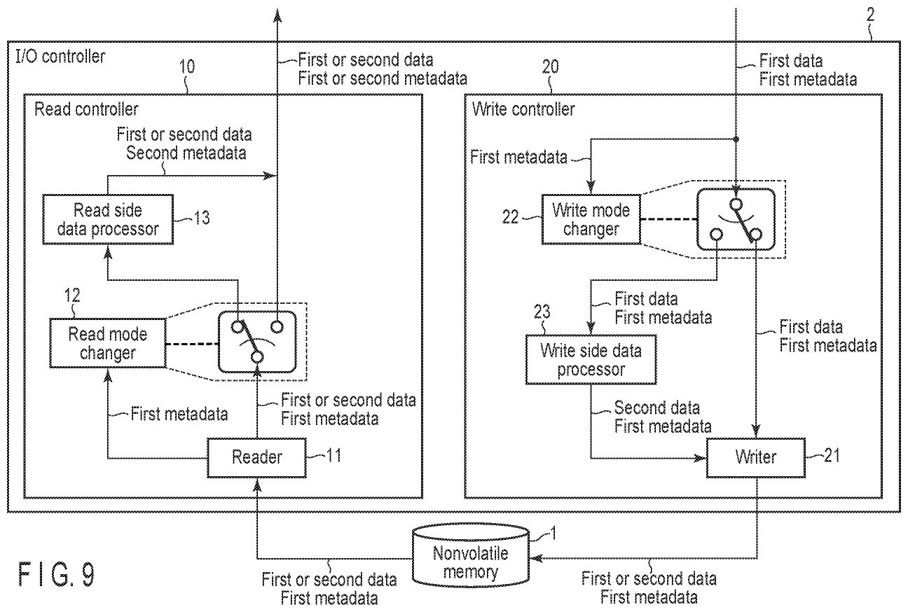

FIG. 9 illustrates a configuration example of an I/O control module 2 according to the present embodiment. The I/O control module 2 is composed of a write control module 20 and a read control module 10. The write control module 20 is composed of a writer 21, a write mode changer 22, and a write side data processor (second data processor) 23. The write mode changer 22 and the write side data processor 23 may be implemented by hardware such as electric circuits or implemented by programs (software) run by processors (not illustrated). The read control module 10 is the same as the read control module 10 in the first embodiment.

The write control module 20 inputs first data and first metadata from an external module, delivers the first data and the first metadata to the writer 21, and delivers the first metadata to the write mode changer 22. The write mode changer 22 determines whether to deliver the first data and the first metadata to the write side data processor 23 or the writer 21, with the first metadata. The write mode changer 22 delivers the first data and the first metadata when, for example, the encoded data is written as it is to the nonvolatile memory 1. When inputting the first data and the first metadata, the write side data processor 23 sequentially processes the first data, and delivers sequentially processed second data and the first metadata to the writer 21. The writer 21 writes the first data and the first metadata input from an external module or the second data and the first metadata input from the writing side data processor 23 to the nonvolatile memory 1.

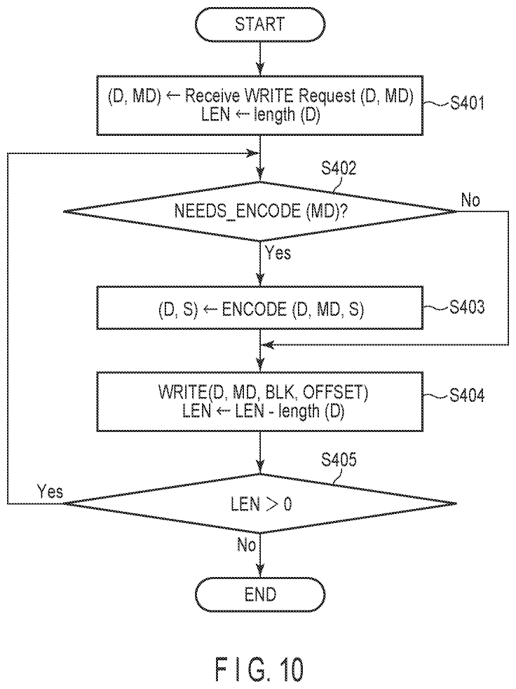

FIG. 10 illustrates a flowchart of the write control module 20 of the present embodiment. The flowchart is different from the flowchart according to the write control module 20 in the third embodiment with respect to determining whether to execute the encoding process in accordance with the metadata MD (S402) and executing the encoding process (S403).

It is assumed that the write control module 20 receives the data D and the metadata MD from the outside (Receive WRITE Request(D,MD)) and specifies the length of the data D (LEN←length(D)) (S401). After that, the write control module 20 determines whether the encoding process needs to be executed by referring to a predetermined field (for example, the Codec Information Pointer (a3) of FIG. 2) of the metadata MD (NEEDS_ENCODE(MD)) (S402).

When determining that the encoding process needs to be executed (for example, when the Codec Information Pointer (a3) of FIG. 2 is not NULL) (S402: Yes), the write control module 20 encodes the data D with information included in the metadata MD and a current state S of the encoder, puts the decoded data to D, and updates the state S of the encoder ((D,S)←ENCODE(D,MD,S)) (S403). When determining that the encoding process does not need to be executed (for example, when the Codec Information Pointer (a3) of FIG. 2 is NULL) (S402: No), the write control module 20 does not execute any process for the data D or the metadata MD.

Next, the write control module 20 writes the data D and the metadata MD to predetermined locations in the nonvolatile memory 1 specified by a block number BLK of a write target logical block and the number of bytes OFFSET from a starting part of the write target logical block (WRITE(D,MD,BLK,OFFSET)). In addition, the length of writing is reduced, and unprocessed data length is updated (LEN←LEN−length(D)) (S404). The flow returns to the write process when unwritten data exists (LEN>0 is true) (S405: Yes) or is ended when unwritten data does not exist (LEN>0 is false) (S405: No). Updating BLK and OFFSET has been described in the third embodiment.

Incidentally, when the updated state S refers to failure, the WRITE operation may be invalidated. Alternatively, the write control module 20 may notify the outside of an error as a response to the request.

The above is the fourth embodiment. The processing required at reading can be executed by allowing not only the data but the metadata including the processing information to be stored in the nonvolatile memory 1 together with the data at the writing. Furthermore, the data can be subjected to an appropriate process before storing in accordance with the state of the metadata and then stored. The data can be used for, for example, encoding multimedia data at the writing, or processing some types of information to an intermediate state and storing the information and executing a final process at the reading, or the like. It is not necessary to execute all processes at reading or writing and becomes easy to respond to situation difference, change of the distribution destination, and the like at writing and reading.

### Fifth Embodiment

Next, a fifth embodiment will be described. In the present embodiment, an operation at the write process is added to the second embodiment. The embodiment is effective when the data size is the same before and after sequential processing, similarly to the second embodiment.

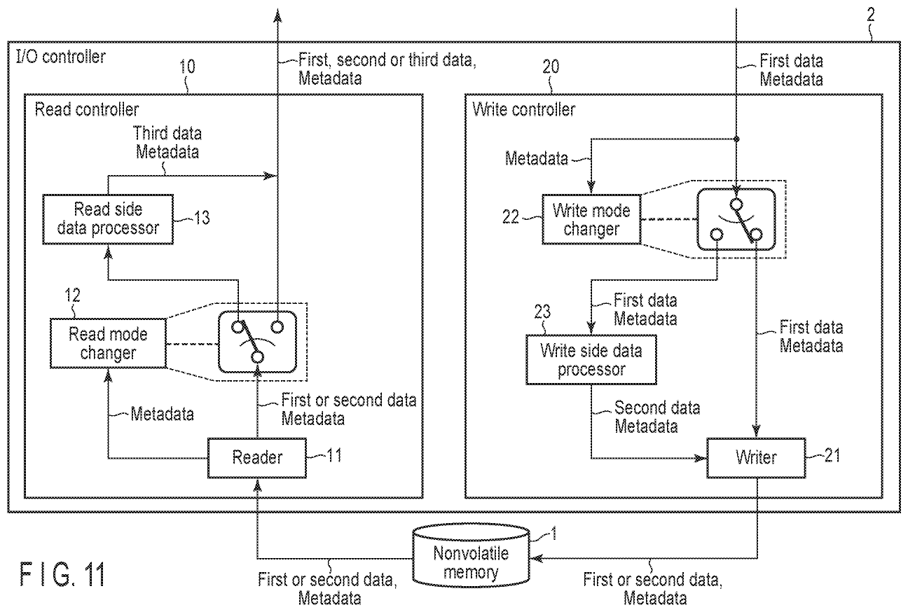

FIG. 11 illustrates a configuration example of an I/O control module 2 according to the present embodiment. The configuration is a configuration obtained by combining the read control module 10 in the second embodiment and the write control module 20 in the fourth embodiment. Since the details of the operation flow and the like are the same as those of the second and fourth embodiments, the details are omitted.

The above is the fifth embodiment. An advantage obtained from a combination of the second and fourth embodiments can be achieved.

### Sixth Embodiment

Next, a sixth embodiment will be described. The present embodiment allows the read control module 10 to determine possibility of outputting a result of a read request and to read the metadata in a manner set for the metadata at the storing, by adding the extended metadata to the read request in the first embodiment.

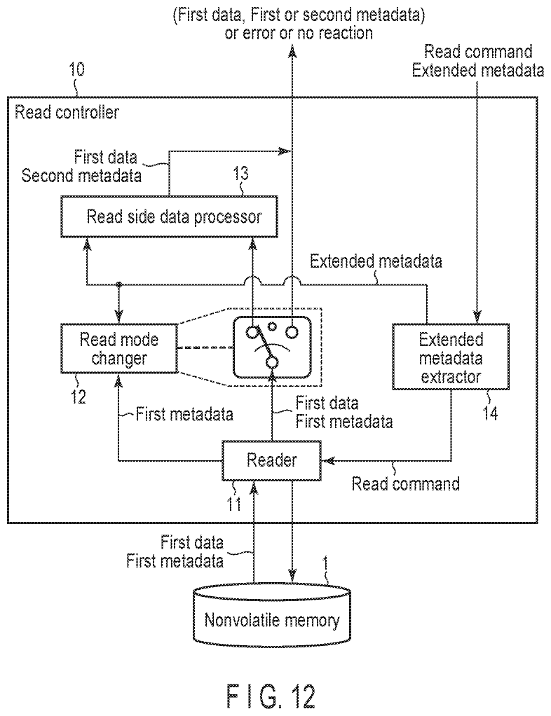

FIG. 12 illustrates a configuration example of a read control module 10 of the present embodiment. In FIG. 12, the read control module 10 is composed of a reader 11, a read mode changer 12, a data processor 13, and an extended metadata extractor 14. The extended metadata extractor 14 comprises a function of fetching extended metadata in response to a read request for the extended metadata extractor 14 and separating the read request and the extended metadata. The fetched extended metadata becomes a new input to the read mode changer 12 and the data processor 13. The extended metadata extractor 14 may be implemented by hardware such as an electric circuit or implemented by a program (software) run by a processor (not illustrated).

The read mode changer 12 changes the read mode with the first metadata read from the nonvolatile memory 1, similarly to the first embodiment, and changes the read mode by also considering the extended metadata. In addition, “not output” can be set in addition to two of “output as it is” and “processed in the data processor” in the read mode. If “not output” is set, the read mode changer 12 does not output the information read from the nonvolatile memory 1. Alternatively, after the read mode changer 12 is controlled to execute processing in the data processor 13, the data processor 13 generates second metadata including error information.

The data processor 13 can sequentially execute processing for the first data and the first metadata and modify each of the data, based on the first metadata, similarly to the first embodiment, and can modify the data in the other form by also referring to the information added with the extended metadata. Then, the data processor 13 makes a response by including a processing result or information specifying a location where the processing result is stored in the second metadata. In addition, when the extended metadata is “not output”, the data processor 13 may execute processing so as to include information indicative of an error in the second metadata. At this time, an only error is included in the second metadata, and a response should not be made with the read data itself. Alternatively, after processing the read first data in a state in which the data cannot be presumed from the original data, the extended metadata may be replaced with the first data and may not be output.

Specifying based on the extended metadata has priority over the first metadata (when the extended metadata is not specified, the specification is based on the instruction of the first metadata). However, the specification may be made separately for each of the read mode changer 12 and the data processor 13 or the specification may be made together for both of them. Alternatively, the order of the process using the first metadata and the process using the extended metadata may be an order of the first metadata extended metadata or the data may be specified as the extended metadata.

As an example of separately specifying the extended metadata, replacing the process specified when the data is stored with the first metadata with the different process of the same type is considered (i.e., the encryption mode and the key length of small strength are changed to the encryption mode and the key length of large strength, the data is output in a state of being encrypted with an encryption key and an encryption algorithm different from the encryption key and the encryption algorithm at the storing, and the like). The instruction to the read mode changer 12 remains “processed in the read mode changer 12”, and the process content of the data processor 13 alone is changed. Thus, the instruction to the read mode changer 12 is not made, but the only instruction to the data processor 13 is made with the extended metadata (in fact, collective specification can be made if the instruction “processed in the data processor” is included in the extended metadata similarly to the instruction at the storing).

In contrast, as an example of specifying collectively, the data stored by considering that processing does not need to be executed at the storing is often newly processed. The only instruction “output as it is” is set in the first metadata, and special instructions or information for the data processor 13 is not included in the first metadata. In contrast, an instruction “to process and then output” can be given with the extended metadata, and information necessary for the instruction can be instructed at the reading.

Since the operation flow of the present embodiment is the same as the operation flow of the first embodiment, a flowchart thereof is omitted.

The above is the sixth embodiment. The process different from the process assumed at the storing can be specified at timing of reading by transmitting the extended metadata together with the read request. Furthermore, reading the information from the nonvolatile memory 1 becomes able to be controlled, based on the authentication information that an authentication subject independent of a generation subject of the read request generates, by allowing “not output” to be specified as the extended metadata.

### Seventh Embodiment

Next, a seventh embodiment will be described. In the present embodiment, the read control module 10 is set to determine the possibility of output of the result of the read request and to read the possibility in a manner different from the assumption at the time of storage, by adding extended metadata to the read request in the second embodiment.

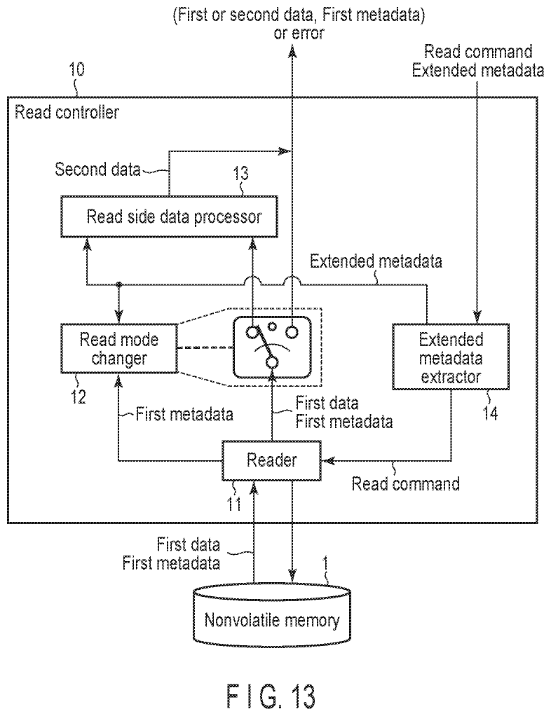

FIG. 13 illustrates a configuration example of a read control module 10 of the present embodiment. The role of the extended metadata and the variation of operation of the read control module 10 have been described in the sixth embodiment. The present embodiment is different from the sixth embodiment with respect to a feature that the process result of the data processor 13 is delivered to a generation source of the read request as second data. For this reason, when “not output” is designated for the extended metadata, no data may be included in the second data or the process result may be returned as the second data such that the original data (first data) cannot be presumed. When notifying an error, means different from that of the data and the metadata may be employed.

The above is the seventh embodiment. The advantage thereof is the same as the advantage obtained from a combination of the second and sixth embodiments.

### Eighth Embodiment

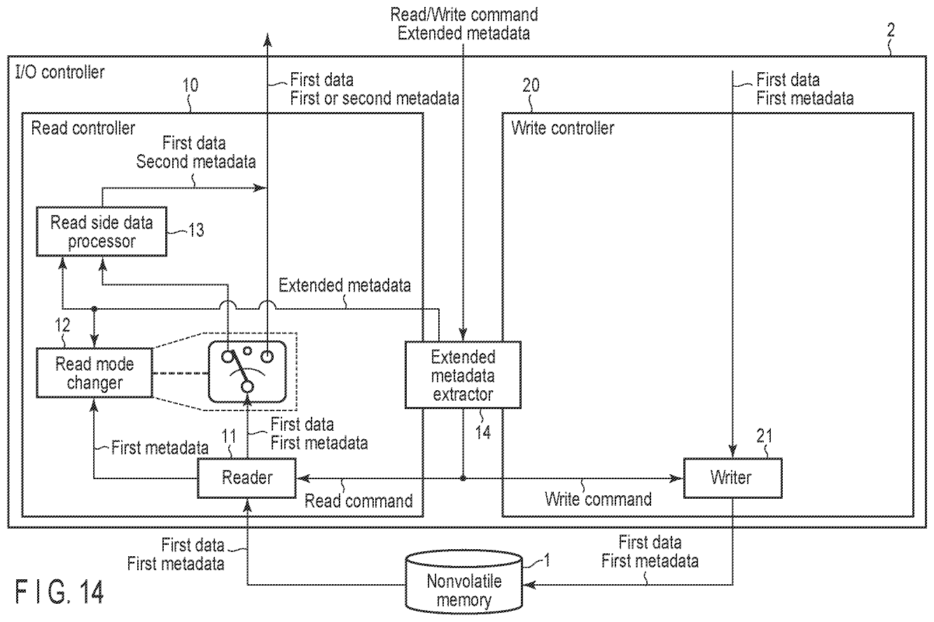

Next, an eighth embodiment will be described. In the present embodiment, extended metadata is added to the read request in the third embodiment and corresponding components are added (FIG. 14). A read control module 10 corresponds to that of the sixth embodiment except that the extended metadata extractor 14 is connected to both the control module 10 and the write control module 20 and that the read request and write request are identified to notify a read module or a write module of the request. The read control module 10 can determine the possibility of output of the result of the read request as an IO control module 2, such that the data can be read in a manner different from the assumption at the time of storage.

Since the detailed description has been made above in the third and sixth embodiments, the detailed description is omitted.

The above is the eighth embodiment. The advantage thereof is the same as the advantage obtained from a combination of the third and sixth embodiments.

### Ninth Embodiment

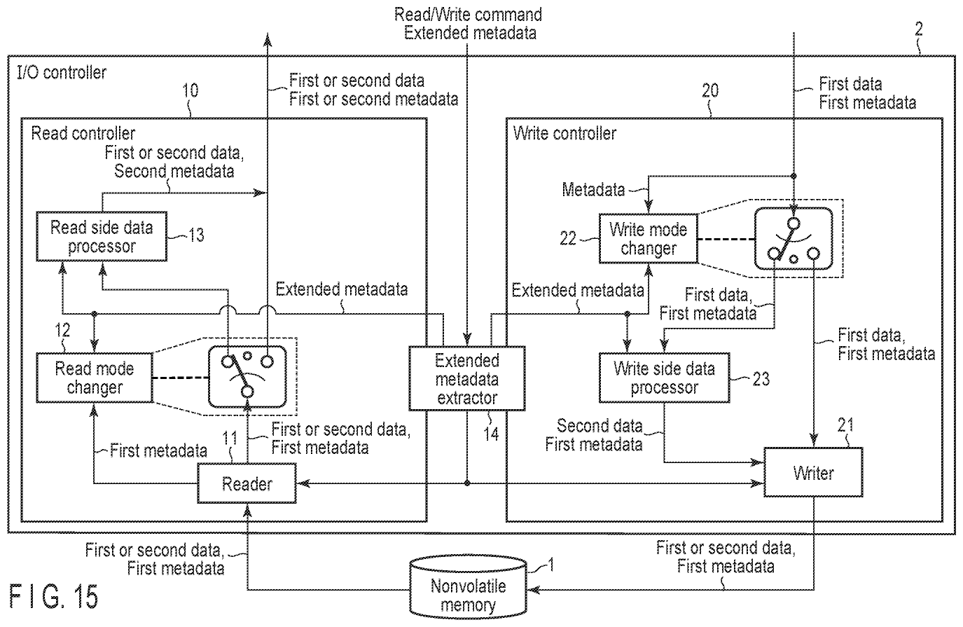

Next, a ninth embodiment will be described. In the present embodiment, extended metadata is added to a read request or a write request in the fourth embodiment and corresponding components are added (FIG. 15). The read control module 10 and the write control module 20 can determine the possibility of output of execution of the read request or the write request, such that the data can be read in a manner different from that of the assumption at the time of storage and can be stored in a manner different from the manner of storage which the generation subject of the storage request assumes.

Since the detailed description on the read side has been made above in the fourth and sixth embodiments, the detailed description is omitted.

The write control module 20 of the present embodiment is composed of a writer 21, a write mode changer 22, and a write side data processor 23. In addition, the write control module 20 is also connected to an extended metadata extractor 14. The extended metadata extractor 14 comprises a function of fetching the extended metadata from the read request or the write request for the IC control module 2. The fetched extended metadata becomes a new input to a read mode changer 12 and a read side data processor 13 or the write mode changer 22 and the write side data processor 23.

The write mode changer 22 changes the write mode with the metadata to be written to the nonvolatile memory 1, similarly to the fourth embodiment, and changes the write mode by considering the extended metadata notified together with the write request. In addition, “not write” can be set in addition to two of “store as it is” and “process in write side data processor”, as write modes. When “not write” is set, the write mode change section 22 does not write requested first data and first metadata to the nonvolatile memory 1. When an error is to be returned, either the write side data processor 23 or the writer 21 may generate the error, and notify the outside of the IC control module 2 of the error by appropriate means (not shown).

The write side data processor 23 can sequentially execute processing for the first data and modify each of the data, based on the first metadata, similarly to the fourth embodiment, and can modify the data in the other form by also referring to the information added with the extended metadata. In addition, when the extended metadata is “not written”, the write side data processor 23 may execute a process of allowing an error to occur and notifying the request source of the error (not shown). At this time, the first data or the first metadata must not be written (i.e., the writ unit is not notified of the information).

Specifying based on the extended metadata has priority over the first metadata input together with the first data of the write target (when the extended metadata is not specified, the specification is based on the instruction of the first metadata). However, the specification may be made separately for each of the write mode changer 22 and the write side data processor 23 or the specification may be made together for both of them. Alternatively, the order of the process using the first metadata and the process using the extended metadata may be an order of the first metadata extended metadata or the data may be specified as the extended metadata.

As an example of separately specifying the extended metadata, replacing the process specified when the data is stored with the first metadata with the different process of the same type is considered. The same example has been described as the example of reading in the sixth embodiment. A case where a shared library or the operating system different from the user application which issues the write request is to replace process contents will be considered here. That is, a case of replacing the process with the other process without modifying the user application will be considered. The library or the operating system hooks the write request, and assigns extended metadata. Then, the instruction to the write mode changer 22 remains “processed in the write side data processor 23” and the information for new processes to be executed in the write side data processor 23 is assigned.

In contrast, as an example of specifying collectively, the shared library or the operating system adds the process that is considered to require no user application. The only instruction “store as it is” is described in the metadata, and special instructions or information for the write side data processor 23 is not included in the metadata. In contrast, an instruction “to process and then store” can be given with the extended metadata, and information necessary for the instruction can be instructed at the write request.

The above is the ninth embodiment. The advantage thereof is the same as the advantage obtained from a combination of the fourth and sixth embodiment and is to further execute controlling with the extended metadata at the writing.

### Tenth Embodiment

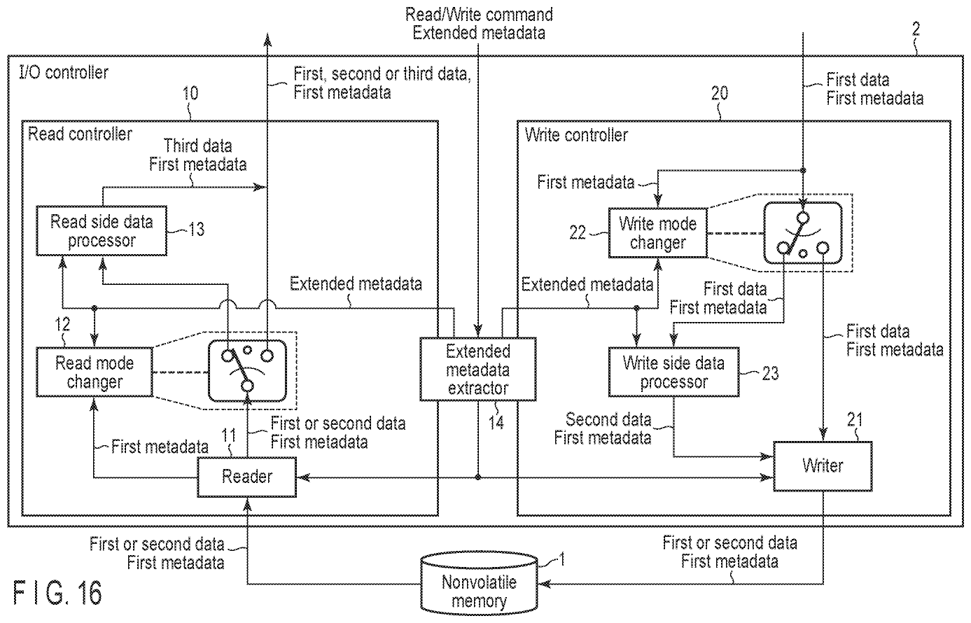

Next, a tenth embodiment will be described. In the present embodiment, extended metadata is added to a read request or a write request in the fifth embodiment and corresponding components are added (FIG. 16). The read control module 10 or the write control module 20 can determine the possibility of output of execution of the read request or the write request, such that the data can be read in a manner different from that of the assumption at the time of storage or can be stored in a manner different from the manner of storage which the generation subject of that storage request assumes.

The detailed description is substantially the same as the above-mentioned ninth embodiment, and the embodiment is merely different from the ninth embodiment in a data outputting method on the read side. The variation is the same as that described in the sixth and seventh embodiments.

The above is the tenth embodiment. The advantage thereof is the same as the advantage obtained from a combination of the fifth and seventh embodiment and is to further execute controlling with the extended metadata at the writing.

### Eleventh Embodiment

Using an IC control module 2 in a system storing the information encrypted by (completely) homomorphic encryption will be described as the eleventh embodiment. The homomorphic encryption is the cryptography which can execute an operation (addition or multiplication or both) as a cryptogram. The types and the number of times of the operation that can be executed are constrained depending on an algorithm and, particularly, a problem that decryption cannot be executed when the number of times of operation exceeds the constraint occurs. For this reason, processes for regularly avoiding the constraint (referred to as Bootstrapping, ModSwitch, and Relinearize; hereinafter referred to as a recovery process) need to be executed. In the present embodiment, these processes will be focused.

Configuration diagrams of the present embodiment are the same as the ninth embodiment (FIG. 15) and the tenth embodiment (FIG. 16). In both the diagrams, the embodiment comprises a read control module 10, but a write process alone is handled here. In addition, only newly added processes relating to the homomorphic encryption will be described here. The processes may be executed together with the processes necessary to implement the above-described embodiments.

The IO control module 2 of the present embodiment receives operated cryptograms obtained by executing the operation for the cryptograms which the homomorphic encryption is applied in a connected host (not shown), as the first data, and receives the information accompanying the cryptograms as the first metadata (a part of the first metadata may be encrypted). In addition, a write process is executed by receiving a write command instructing the cryptograms to be written and the accompanying extended metadata. The extended metadata includes the necessity of execution of the recovery process and information necessary to execute the recovery process additionally (to the information described in the above embodiments).

When receiving the above write command, an extended metadata extractor 14 fetches the extended metadata and transmits the extended metadata to a write mode changer 22 and a write side data processor 23. The write mode changer 22 executes change by referring to the information relating to the necessity of execution of the recovery process as included in the extended metadata. When it is instructed that the recovery process is necessary, the write mode changer 22 changes to deliver the first data and the first metadata to the write side data processor 23. When it is instructed that the recovery process is unnecessary, the write mode changer 22 delivers the first data and the first metadata to the writer 21 as they are.

The write side data processor 23 executes an appropriate recovery process according to each algorithm, by referring to information necessary for the recovery process included in the extended metadata. The result becomes the second data and is delivered to the writer 21 together with the first metadata.

The writer 21 stores the first metadata that is not subjected to the recovery process, or the second data that is subjected to the recovery process, and the accompanying first metadata, in the nonvolatile memory 1.

Incidentally, since the recovery process is accompanied by complicated calculation, the recovery process may require more time than the other processes that the IO control module 2 of the present embodiment assumes and may inhibit a subsequent write process. For this reason, when the present embodiment is applied, a plurality of write side data processors 23 may be prepared or the write side data processor 23 may be provided independently as a dedicated circuit.

Since the operation flow of the present embodiment is the same as the operation flow of the ninth or tenth embodiment, the operation flow is omitted.

The above is the present embodiment. Conventionally, a part executing the arithmetic processing of the cryptogram, such as the CPU, has executed the recovery process of the homomorphic encryption, but can be replaced with the IO control module 2 of the present embodiment. Since the CPU or the like can appropriately determine the timing for requiring the recovery process, the CPU may transmit cryptograms as extended meta-information together with the instruction of the recovery process only when storing the operated cryptograms of the homomorphic encryption which are expected to be reused.

### Twelfth Embodiment

Next, a twelfth embodiment will be described. The present embodiment is also directed to a cryptogram encrypted by homomorphic encryption, similarly to the eleventh embodiment. In the present embodiment, executing the recovery process while executing a plurality of read commands that execute the process while reading a cryptogram will be considered.

Configuration diagrams of the present embodiment are the same as the sixth embodiment (FIG. 12) and the seventh embodiment (FIG. 13). When the embodiment executes the process as not the read control module 10, but the IC control module 2 accompanying the write control module 20, the ninth embodiment (FIG. 15) and the tenth embodiment (FIG. 16) are used similarly. In the present embodiment, it is assumed that cryptograms encrypted in advance by the homomorphic encryption are stored in a plurality of nonvolatile memories 1.

A read control module 10 of the present embodiment starts the process by receiving a Read command that reads a cryptogram and metadata corresponding thereto from the connected host (not shown) and the accompanying extended metadata, by the extended metadata extractor 14. The extended metadata extractor 14 fetches the extended metadata, and transmits the extended metadata to the read mode changer 12 and the read side data processor 13. In addition, the extended metadata extractor 14 notifies the nonvolatile memory 1 of the Read command via the reader 11. The nonvolatile memory 1 receiving the Read command reads the first data that is a cryptogram and the accompanying first metadata from a predetermined region.

The extended metadata of the present embodiment includes information relating to an operation instruction for the cryptogram that is the read first data, and an execution instruction of the recovery process of the operated cryptogram (=second data). The operation instruction includes the necessity of operation and the type of operation for both the first data and the cryptogram read immediately before, and the necessity of operation and the type of operation (including the operand designation) for the first data and the result of the operation executed immediately before. The execution instruction of the recovery process may include information necessary for the execution in addition to the necessity of the recovery process.

The read mode changer 12 changes the output based on the first metadata and the extended metadata. When the extended metadata is instructed that “an operation is necessary” or “the recovery process is necessary”, the first data is delivered to the read mode changer 12.

The data processor 13 executes the operation instructed by the extended metadata or the recovery process. In the case of the operation instruction, the operation (addition or multiplication, comparison, or other indicated operation) between the first data input to the data processor 13 by reading immediately before or the output second data or a value input as the extended metadata, and the first data that is being currently processed is executed. Then, the operation result is referred to as the second data. The data processor 13 stores at least one of the first data and the second data as an internal state to prepare for the operation instruction in a subsequent read process. For this reason, a temporary storage unit may be added to the data processor 13 in the present embodiment. Information indicative of the necessity of the recovery process may be included as the internal state. In addition, the number of times of remaining operations (level value) until the next recovery process may be used as the information indicative of the necessity of the recovery process.

Furthermore, the recovery process is necessary for the second data that is the operation result, in accordance with the states of two data that are to be inputs. At this time, the necessity of the recovery process may be included in either output (second data inside or the first metadata or second metadata (depending on the configuration)). The host (not shown) that has received the information indicative of the necessity of the recovery process may execute the recovery process by itself or may update the information with the recovery process by the method of the eleventh embodiment when reuse of the information is expected.

The above is the twelfth embodiment. When reading information encrypted by the homomorphic encryption, the cryptogram can be subjected to a necessary operation as it is, by applying the present embodiment. In addition, the necessity of the recovery process can be detected and notified to the host. For this reason, the host can obtain the operation result without executing a complicated operation. In addition, it can be detected rapidly that the recovery process is necessary.

Incidentally, the nonvolatile memory 1 in each of the embodiments may be either a block type storage or a Key-Value type storage, or may be any one of SSD, HDD, and a Storage Class Memory (SCM). When the nonvolatile memory 1 is a block type storage, in NVMe SSD, the Read command and the Write command of NVMe may be used as the I/O commands between the read control module 10 and write control module 20, and an external module, in each embodiment. When the nonvolatile memory 1 is a Key-Value type storage, in NVMe SSD, the Retrieve command and the Store command of NVMe may be used as the I/O commands between the read control module 10 and write control module 20, and an external module, in each embodiment. In addition, when a block type storage is used as the nonvolatile memory 1 in each of the embodiments, the metadata may be read or written with ioctl( ) system call of the host OS and, in this case, each of METADATA GET command and METADATA SET command may be used.

In addition, a case where the write control module 20 is provided independently is not described in each of the above embodiments. However, in a case where the only write process is to be controlled, the write control module 20 may be executed alone.

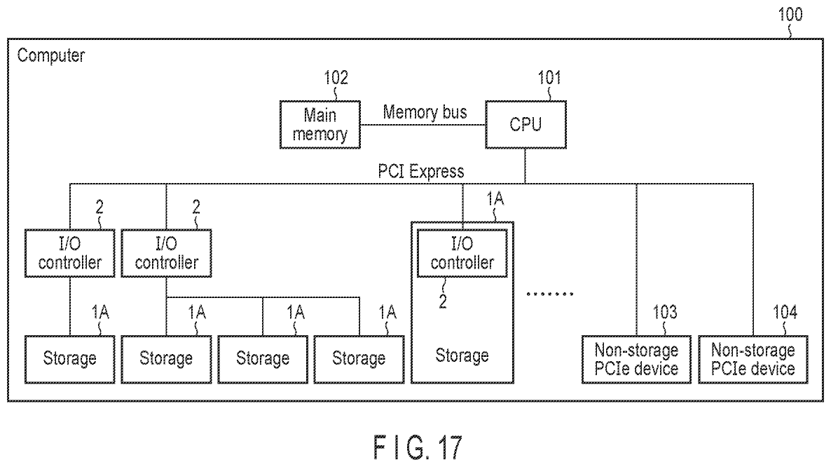

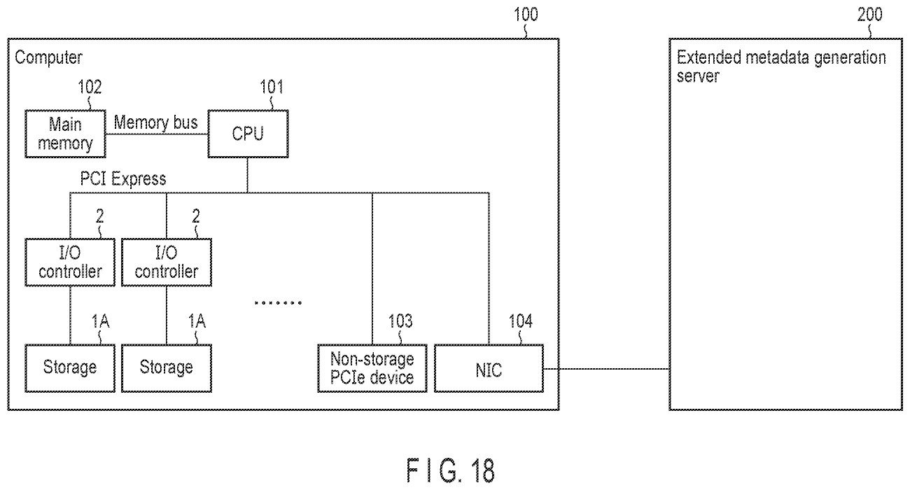

FIG. 17 and FIG. 18 are diagrams illustrating positioning the I/O control module 2 of each of the embodiments for use in the calculating machine (computer) 100 or a computer system.

FIG. 17 illustrates an example in which the IO control module 2 is attached to a system in a form of accompanying storages 1A such as SSD. In the example of the IO control module 2 on the leftmost side in FIG. 17, the IO control module 2 is external to the storage 1A. In the example of the IO control module 2 on the second left side in FIG. 17, a plurality of storages 1A are connected to one control module 2. It is assumed that, for example, the function of the IO control module 2 of each of the embodiments is incorporated into the part such as a RAID controller or that a function of processing the storage protocol and the function of the IO control module 2 of each of the embodiments are incorporated into a bridge chip such as a PCI Express switch. In the example of the IO control module 2 on the third left side in FIG. 17, the IO control module 2 is integrated with the inside of the storage 1A. In either case, the IO control module 2 may be replaced with the read control module 10 if only reading is controlled or may be replaced with the write control module 20 if only writing is controlled. The essential function of the IO control module 2 of each of the embodiments is not limited according to whether the IO control module 2 is provided outside or inside the storage 1A.

In addition, the read request and the write request are not limited in the case where they are generated by the software running on the CPU of this figure. For example, the read request and the write request may be generated by the software run on another calculating machine connected through a network.

FIG. 18 illustrates a case where the function of generating the “extended metadata”, which is added in the sixth to tenth embodiments, is installed outside the calculating machine (computer) 100 including the components such as the read control module 10 and the write control module 20 of each of the embodiments or the computer system (extended metadata generation server 200) and is connected through some network. A network using TCP/IP or any network may be used as the network. Alternatively, FIG. 18 illustrates the server as a server installed outside physically. The server may be a logically separated calculating machine (virtual calculating machine or the like). In either case, it has been described in a series of embodiments that the components such as the software running by the same calculating machine as the generation source of the read request or the write request generate the extended metadata. As illustrated in FIG. 18, however, an outside server may generate the extended metadata and the information in a state of being buried as extended meta-information may reach the IO control module 2 of each of the embodiments.

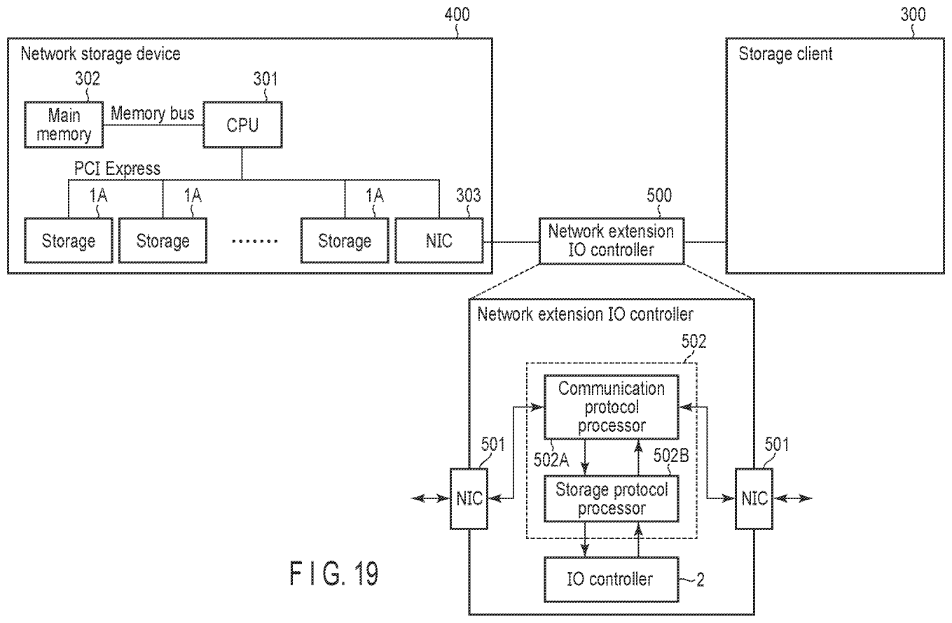

FIG. 19 illustrates a case where a storage client 300 generating the read request and the write request is connected to a device (network storage device 400) including the storages 1A through a network. A network extension IO control module 500 comprising the function of the IO control module 2 of each of the embodiments is connected to the middle of the network. In this case, the network extension IO control module 500 needs to comprise a communication function. More specifically, the communication function is a function of receiving the read request and the write request transmitted and received through a network and retransmitting the read request and the write request after adding an appropriate change thereto, and comprises a network interface unit 501 which physically connects to the network and a protocol processor 502 which processes communication protocols such as TCP/IP and storage protocols such as iSCSI and NVMeoF (separable into a communication protocol processor 502A and a storage protocol processor 502B). The read request and the write request extracted via them may be input and output between the IO control modules 2 described in each of the above embodiments.

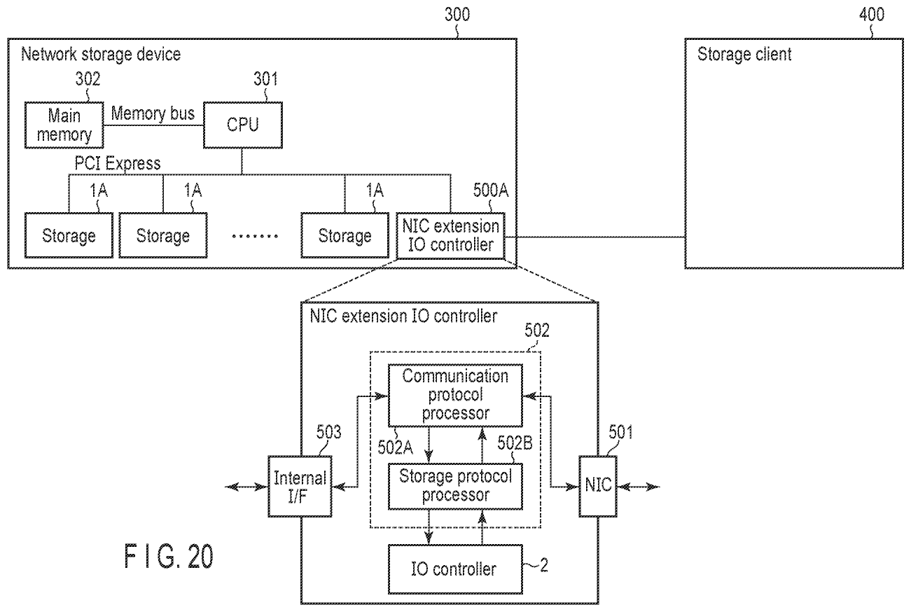

FIG. 20 illustrates a case where the network extension IO control module 500 illustrated in FIG. 19 is integrated with a network interface (NIC extension IO control module 500A). In FIG. 20, one of NIC 501 is replaced with an internal I/F 503.

Based on the above, each of the embodiments reads the data and the metadata that are to be sequentially processed for the nonvolatile memory, determines whether to apply the sequential processes based on the information on the sequential processes of the metadata and, when the sequential processes are applied, executes the sequential processes of the data while referring to the sequential process state stored inside, and includes the processed data in the metadata and outputs the metadata to the external module together with the data or, when the sequential processes are not applied, outputs the read data and the read metadata as they are to the external module, and can thereby remarkably reduce the CPU process load. In addition, when data redistribution is executed, the data can be read as it is without executing sequential processes for the data, similarly to the conventional storage.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A read controller configured to read data to be subjected to sequential processing and metadata from a nonvolatile memory, the read controller comprising:
a reader configured to read first data and first metadata from the nonvolatile memory;
a read mode changer configured to determine whether or not to execute the sequential processing for the first data based on the first metadata; and
a first data processor, when the read mode changer determines that the sequential processing is to be executed, configured to
store information necessary for the sequential processing,
execute the sequential processing for the first data, and
generate second metadata including a result of the sequential processing,
wherein the read controller is configured to output the first data, and the first metadata or the second metadata.

2. A read controller configured to read data to be subjected to sequential processing and metadata from a nonvolatile memory, the read controller comprising:
a reader configured to read first data and first metadata from the nonvolatile memory;
a read mode changer configured to determine whether or not to execute the sequential processing for the first data based on the first metadata; and
a first data processor, when the read mode changer determines that the sequential processing is to be executed, configured to
store information necessary for the sequential processing,
execute the sequential processing for the first data, and
generate second data including a result of the sequential processing,
wherein the read controller is configured to output the first data or the second data, and the first metadata.

3. An input/output controller comprising:
the read controller of claim 1; and
a write controller configured to write data and metadata,
wherein the write controller comprises a writer configured to write the first data and the first metadata input from an outside to the nonvolatile memory.

4. An input/output controller comprising:
the read controller of claim 1; and
a write controller configured to write data and metadata, wherein the write comptroller comprises:
a write mode changer configured to input the first data and the first metadata from an outside, and to determine whether or not to execute sequential processing for the first data based on the first metadata;
a second data processor, when the write mode changer determines that the sequential processing is to be executed, configured to
store information necessary for the sequential processing,
execute the sequential processing for the first data, and
generate second data including a result of the sequential processing; and
a writer configured to write one of the first data and the second data, and the first metadata to the nonvolatile memory.

5. An input/output controller comprising:
the read controller of claim 2; and
a write controller configured to write data and metadata, wherein the write comptroller comprises:
a write mode changer configured to input the first data and the first metadata from an outside, and to determine whether or not to execute sequential processing for the first data based on the first metadata;
a second data processor, when the write mode changer determines that the sequential processing is to be executed, configured to
store information necessary for the sequential processing,
execute the sequential processing for the first data, and
generate second data including a result of the sequential processing; and
a writer configured to write one of the first data and the second data, and the first metadata to the nonvolatile memory.

6. The read controller of claim 1, further comprising an extended metadata extractor configured to
receive from an outside a read command of instructing reading the first data and the first metadata from the nonvolatile memory and extended metadata accompanying the read command,
separate the read command and the extended metadata,
transmit the read command to the reader, and
notify the read mode changer and the first data processor of the extended metadata, wherein
the read mode changer is configured to determine whether or not to execute the sequential processing for the first data in accordance with the first metadata and the extended metadata and/or whether or not to output the read data, and
the first data processor is configured to execute operations of:
when the read mode changer determines that the sequential processing is to be executed, executing the sequential processing for the first data, based on at least one of the first metadata and the extended metadata, and generating the second metadata including a result of the sequential processing;
when the read mode changer determines that the sequential processing is to be executed, outputting the first data and the second metadata to the outside;
when the read mode changer determines that the sequential processing is not to be executed, outputting the first data and the first metadata to the outside; and
when the read mode changer determines that the read data is not to be output, outputting the first metadata alone to the outside, or outputting the second metadata alone including occurrence of an error, or outputting none of the first metadata and the second metadata.

7. The read controller of claim 2, further comprising an extended metadata extractor configured to
receive from an outside a read command of instructing reading the first data and the first metadata from the nonvolatile memory and extended metadata accompanying the read command,
separate the read command and the extended metadata,
transmit the read command to the reader, and
notify the read mode changer and the first data processor of the extended metadata, wherein
the read mode changer is configured to determine whether or not to execute the sequential processing for the first data, based on the first metadata and the extended metadata and/or whether or not to output the read data, and
the first data processor is configured to execute operations of:
when the read mode changer determines that the sequential processing is to be executed, executing the sequential processing for the first data based on at least one of the first metadata and the extended metadata, and generating the second data including a result of the sequential processing;
when the read mode changer determines that the sequential processing is to be executed, outputting the second data and the first metadata to the outside;
when the read mode changer determines that the sequential processing is not to be executed, outputting the first data and the first metadata to the outside; and
when the read mode changer determines that the read data is not to be output, outputting the first metadata alone to the outside, or outputting the second data including data indicative of an error, or outputting none of the first metadata and the second data.

8. The input/output controller of claim 4, further comprising an extended metadata extractor configured to
receive from an outside a read command of instructing reading the first data and the first metadata from the nonvolatile memory and extended metadata accompanying the read command,
separate the read command and the extended metadata,
transmit the read command to the reader, and
notify the read mode changer and the first data processor of the extended metadata, wherein
the write mode changer is configured to determine whether or not to execute the sequential processing for the first data, based on the first metadata and the extended metadata and/or whether to write the received first data,
the second data processor is configured to execute operations of:
when the write mode changer determines that the sequential processing is to be executed, executing the sequential processing for the first data and generating the second data including a result of the sequential processing;
when the write mode changer determines that the sequential processing is to be executed, writing the second data and the second metadata to the nonvolatile memory;
when the write mode changer determines that the sequential processing is not to be executed, writing the first data and the first metadata to the nonvolatile memory; and
when the write mode changer determines that the sequential processing is not to be executed, writing none of the first data and the first metadata to the nonvolatile memory,
the read mode changer is configured to determine whether or not to execute the sequential processing for the read data in accordance with the first metadata and the extended metadata and/or whether to output the read data, and
the first data processor is configured to execute operations of:
when the read mode changer determine that the sequential processing is to be executed, executing the sequential processing for the first data, based on at least one of the first metadata and the extended metadata, and generating the second metadata including a result of the sequential processing;
when the read mode changer determines that the sequential processing is to be executed, outputting the first data or the second data, and the second metadata to the outside;
when the read mode changer determines that the sequential processing is not to be executed, outputting the first data or the second data, and the first metadata read from the nonvolatile memory to the outside; and
when the read mode changer determines that the read data is not to be output, outputting the first metadata alone to the outside, or outputting the second metadata including data indicative of an error, or outputting none of the first metadata and the second data.

9. The input/output controller of claim 5,
further comprising an extended metadata extractor configured to receive from an outside a read command of instructing reading the first data and the first metadata from the nonvolatile memory and extended metadata accompanying the read command,
separate the read command and the extended metadata,
transmit the read command to the reader, and
notify the read mode changer and the first data processor of the extended metadata, wherein
the write mode changer is configured to determine whether or not to execute the sequential processing for the first data, based on the first metadata and the extended metadata and/or whether or not to write the received first data,
the second data processor is configured to execute operations of:
when the write mode changer determines that the sequential processing is to be executed, executing the sequential processing for the first data and generating second data including a result of the sequential processing;
when the write mode changer determines that the sequential processing is to be executed, writing the second data and the second metadata to the nonvolatile memory;
when the write mode changer determines that the sequential processing is not to be executed, writing the first data and the first metadata to the nonvolatile memory; and
when the write mode changer determines that the received first data is not to be written, writing none of the first data and the first metadata to the nonvolatile memory,
the read mode changer is configured to determine whether or not to execute the sequential processing for the read data in accordance with the first metadata and the extended metadata and/or whether or not to output the read data, and
the first data processor is configured to execute operations of:
when the read mode changer determines that the sequential processing is to be executed, including executing the sequential processing based on at least one of the first metadata and the extended metadata, and generating third metadata including a result of the sequential processing;
when the read mode changer determines that the sequential processing is to be executed, outputting the third data and the first metadata to the outside;
when the read mode changer determines that the sequential processing is not to be executed, outputting the first data or the second data, and the first metadata read from the nonvolatile memory to the outside; and
when the read mode changer determines that the read data is not to be output, outputting the first metadata alone to the outside, or outputting third data including data indicative of an error, or outputting none of the first metadata and the second data.

10. The read controller of claim 1, further comprising a nonvolatile memory.

11. The input/output controller of claim 3, further comprising a nonvolatile memory.

12. The read controller of claim 1, wherein the read controller is configured to execute multimedia encode processing and multimedia decode processing as the sequential processing.

13. The input/output controller of claim 3, wherein the input/output controller is configured to execute multimedia encode processing and multimedia decode processing as the sequential processing.

14. The read controller of claim 1, wherein the read controller is configured to execute security encryption processing and security decryption processing as the sequential processing.

15. The input/output controller of claim 3, wherein the input/output controller is configured to execute security encryption processing and security decryption processing as the sequential processing.

16. The read controller of claim 1, wherein the read controller is configured to execute data compression processing and data decompression processing as the sequential processing.

17. The input/output controller of claim 3, wherein the input/output controller is configured to execute data compression processing and data decompression processing as the sequential processing.

18. The read controller of claim 1, wherein the read controller is configured to execute a digital signature computation process to a blockchain digital ledger as the sequential processing.

19. The input/output controller of claim 3, wherein the input/output controller is configured to execute a digital signature computation process to a blockchain digital ledger as the sequential processing.
